(19) United States
(12) Patent Application Publication
(10) Pub. No.: US 2001/0037495 A1
(43) Pub. Date: Nov. 1, 2001

(54) Memory access method by referencing data, and data processing device using the same

(76) Inventors: Motoyuki Kato, Kyoto-fu (JP); Hiroyuki Yanagi, Kyoto-fu (JP); Shinji Nakagawa, Kyoto-fu (JP); Yosuke Baba, Kyoto-fu (JP)

Correspondence Address: Thomas J. D'Amico, DICKSTEIN SHAPIRO MORIN & OSHINSKY LLP, 2101 L Street NW, Washington, DC, 20037-1526, US

(21) Appl. No.: 09/804,244

(22) Filed: Mar. 13, 2001

(30) Foreign Application Priority Data
Mar. 13, 2000 (JP) H12-069113

(51) Int. Cl. G06F 9/45

(52) U.S. Cl. 717/5; 717/10

(57) ABSTRACT

The objective of this invention is to realize an information processing scheme such that the necessary references, including reference data specifying locations to be accessed in the memory, are found before the program is executed, and each result is stored in a link to the program. Then the locations to be accessed can be specified immediately by the reference data when the program is executed. The program's running time is stabilized and its speed is increased. It is well suited for use in a device which requires real time capability. when a program written in an interpreter language is run, the reference data specifying the locations to be accessed in the memory are extracted and the references are found before the program is executed. The results which are obtained are then linked to the program through the aforesaid reference data. When a program is executed which requires that certain data be referenced and accessed in the memory, the locations to be accessed in the aforesaid memory are specified based on the results linked to the program through these reference data.

### FIELD OF THE INVENTION

This invention concerns a scheme to execute a program through the use of an interpreter language and an information processing device which contains such a program. More specifically, this invention concerns a technique to execute a program which requires that destinations to be accessed in the memory be specified by referencing data.

### BACKGROUND OF THE INVENTION

Java®, the object-oriented programming language developed by Sun Microsystems, operates in an environment which has a Java interpreter to convert Java commands into byte code without having to rely on a platform. It has received a great deal of attention as a language which is well-suited to set values in information processing systems contained in various devices.

To prevent improper access to the memory, information processing systems using Java do not allow the program to directly specify a destination to be accessed in the memory, but instead specify the destination indirectly through data representing its name.

For example, a program indicating that a value should be set in a variable (i.e., in a field) or that this value be read out would designate the variable by the name of the class to which it belongs, the name of the variable and the name of the type of variable (e.g., int or byte). Programs that access methods designate the method they wish to access by the name of the class to which the method belongs and the name of the method. Generally, the processing entailed in using a given convention (such as character data indicating a name) to find the lo3 cation where data are stored concerning something to be processed (a variable, a method, a class, etc.) is called “referencing.” Indicating that data are to be referenced is called a “reference request.” (For example, referencing a variable, a method or a class is called a “field reference, ” a “method reference” or a “class reference.”)

When executing a program which requests a reference using a given name as data, the Java interpreter which is called a “virtual machine” will retrieve the specified reference table (as will be explained in detail shortly) by means of the data represented by the name and specify the address where the data to be referenced are stored. Referencing data designated in this way and indicating the location where they are stored is called “resolving a reference.”

FIG. 6 shows the compiled result of a program which uses Java. In the figure, each dotted rectangle is one unit's worth of program code. Each code contains multiple data points. In the example, individual data are shown in the white boxes.

In FIG. 6, 10 is the byte code program obtained by converting the message indicating that a value should be assigned to the variable. (In assembler code this is represented as “putstatic Sample.value:int”.) It consists of instruction code representing the content of the request (B3) and an operand representing the address (00 06) where the content which the instruction indicated was to be referenced can be found. (Hereafter, an object program with an instruction code attached will be referred to as an “instruction.”)

Reference data configured as shown on the right in the figure are linked to instruction 10. These data consist of a combination of various lengths of code data, to the head of which is attached a tag representing the type of data. An identification number called the “constant pool entry number” (hereafter, called simply the “entry number”) is attached to each set of code data, and a link is set up for each entry number. The first entry number for reference data, 06, is written into the aforesaid operand. By following the links between the various sets of code data in order, starting from the first entry, we can obtain a character string representing the name of the class, the variable, and the type of variable that were described to the source program.

These reference data are stored in class units. (Hereafter, reference data in class units are referred to as “class file data.”) To simplify the explanation, in FIG. 6 the reference data which have been selected are for a single instruction. Entry numbers not shown in the figure are used for the reference data for other instructions.

In the figure, character data representing the class name “Sample” are recorded in entry number 20; data representing the variable name “Value” are recorded in entry number 27. The character string “I”, which represents int, the name of the type of variable, is recorded in entry number 17. The character strings of data in entry numbers 20, 27 and 17 are encoded. Code data representing the number of bytes in the character string and the tag “01”, which indicates that character strings of encoded data are recorded, are added in front of the encoded data.

The data in entry numbers 1, 6 and 9 indicate what location the aforesaid character string is to reference.

The data for entry number 6 have the tag “09”, which means “field reference”. This tag indicates that the following data are field reference data. Code data representing the entry numbers 1 and 9 are recorded in entry number 6.

The tag “07”, which means “class reference”, is attached to entry number 1. This sets up a link in the character data which represent the aforesaid class name to connect this entry number with entry number 20, the destination to be referenced. The tag “0C”, which means “name and type reference”, is attached to entry number 9. This links entry number 9 to entry number 27, where the character data for the aforesaid variable name are stored, and entry number 17, where the name of the type of variable is stored.

This configuration of data allows us to follow the links in the reference data in an orderly fashion beginning with entry number 6, which is written into the operand of instruction 10. In this way we can obtain the names of the class, the variable and the type, which we need for a field reference. Other commands express the data in the same fashion. When the source program is compiled, instructions are generated which serve as links to the reference data that represent the actual content of the designated reference.

Reference data can be shared among a number of instructions which all require the same reference. For example, let us assume that the aforesaid instruction 10 occurs in a number of places in the program, and that there is another instruction (for example, an instruction obtained from the program “getstatic Sample.Value:int”) which requires the same field reference as instruction 10. The aforesaid entry number 6 is then written into the operand of each of these instructions to set up a link to the reference data in the aforesaid FIG. 6.

When the interpreter executes each instruction, it recognizes the content of the command from the aforesaid instruction. It follows the links in order starting from the entry number written into the operand, and it finds the content of the designated reference and the data which represent the name used in the reference.

For the different variables and methods set up in each class, a reference table is created in the system to specify from the name data the location in the memory where those variables and programs are stored. The interpreter uses the name data it obtains from the aforesaid reference data to look up the aforesaid reference table. It executes the necessary processing to find the destination designated by the aforesaid instruction.

FIG. 7 shows the configuration of the table of classes and the table of fields (11 and 12 in the drawing) used to find field references. In FIG. 7, 13 is a heap memory which serves as the work area for all the objects designated by the program. 14 is a table where character strings such as names of classes or variables are stored.

As the aforesaid class file data are generated, data concerning the class are stored in the aforesaid tables 11 and 12. Data stored in class table 11 include the top address of the class; the top address of the string; the name index for the class itself; the name index for the parent class (the super index); the size of objects in the class; and access flags. (Hereafter, these data are all called “class data”.)

The top address of a class is the address where the head data of the aforesaid class file are stored. The top address of the string is the head address of the area in table 14 where character strings such as the names of classes and variables for each class are stored. The name index consists of the constant pool entry numbers which indicate the names of the classes in the aforesaid reference data. Access flags indicate whether or not a class can be accessed.

An individual index (hereafter referred to as a “class table index” ) is attached to the class data for each class.

For every variable the program creates, various data are stored in the field table, including an object offset; an index to the class table; a name index; a type index; and access flags. (Hereafter, these data are collectively referred to as “field data”.)

The aforesaid object offset is a value indicating the relative location of the field assigned to the aforesaid variable in the work area for the object which contains that variable. This value is determined when the class file data are created. The size of the work area is determined in which the instance of each class must be stored in a heap memory, and a storage area is allotted for each variable in this work area.

However, values for static variables are themselves stored in the field table.

The index to a class table is attached to the class data in the aforesaid class table for the class which contains the aforesaid variable. Name and type indices are constant pool entry numbers for the data which represent variable and type names in the aforesaid reference data. Access flags, as was just as was described above, indicate whether or not a variable can be accessed.

A separate index (Hereafter referred to as a “field table index”) is attached to each set of file data.

To find a field reference, the interpreter uses the name of the class it obtains from the reference data linked to the aforesaid instruction to retrieve the class table and get the table index for that class. It then retrieves the field table and extracts from the data containing the aforesaid index the field data whose variable and type names match the names it got from the aforesaid reference data. It gets the address of the storage area assigned to the variable from the object offset value in the field data.

If the interpreter is to execute the same instruction again, when it obtains the result of referencing the aforesaid field, it rewrites the instruction code from the aforesaid instruction into the code which it has found. It rewrites the operand into the number of the field table index it obtained from the aforesaid field reference. As a result of this rewriting, when the interpreter executes the instruction, it can immediately read the object offset that is in the field table from the field table index written in the operand and thereby obtain the location where the designated variable is stored.

To aid in referencing methods, a reference table (the method table) is set up to direct the interpreter, via class and method names, to the locations where programs for methods are stored. The interpreter obtains the index for the method table from the instruction and from the name of the method it reads out of the reference data linked to the instruction, and in this way it references the method. If it is to execute the instruction again, the interpreter rewrites its operand in the aforesaid index for the method table which it has obtained.

FIG. 8 shows the chain of processing in a system using a byte code program generated by the aforesaid Java source program, from the time the system is started until the program is completed.

The object program and class file data constituting this system are stored in an internal ROM. When power is supplied to start the system, the object program is loaded into a RAM, and the class which is to be activated first by the start-up program is indicated (Step 1). In Step 2, the class file data for the indicated class are read out into the RAM. In Step 3, the data for the aforesaid class whose file data have been read out are stored in various reference tables, including the class table, the field table and the method table.

In Step 4, when the environment for executing an instruction has been arranged in this way, the first instruction is read. If this instruction requires that a class be referenced for which class file data have not yet been created, we move from Step 5 to Step 6 and designate that file data be created for this class. In response, file data are created and entered into the reference tables in Steps 2 and 3. When this has been completed, the aforesaid instruction is read again.

If file data already exist for the class whose reference is required by the instruction, the interpreter finds the names of the class, variable and method in the file data. If this instruction is the first one executed after the system is started up, its instruction code will not have been referenced yet, so we proceed from Step 7 to Step 8.

In Step 8, the interpreter follows the link in the file data from the entry number written into the operand of the aforesaid instruction and finds the names of the class and the variable (or the method). From the names it has found, it references the various tables and finds the references which specify the locations where the variable and the method program are stored. In Step 9, the interpreter accesses the addresses it obtained by finding the aforesaid references. When it has completed the instruction, it goes from Step 10 back to Step 4. Thereafter, the same processing is executed for each instruction.

When the reference processing is completed in Step 8, the instruction code and operand in the completed instruction are rewritten. When this rewritten instruction is read, the interpreter proceeds from Step 7 to Step 9 and executes the aforesaid instruction without having to find the references.

If we follow the procedure described above, when the first instruction is executed after the system is started, all instructions requiring references must execute the processing in Step 8. In this processing, as was discussed earlier, several stages of referencing must be pursued to arrive at the storage location of the variable or method. This causes a considerable delay between the time the instruction is read and the time it is executed. This causes the processing to be extremely slow when a program is executed immediately after the system is started. Further, since a program's running time immediately after the system is started will be different from the same program's running time the second time or third time it is run, when its references have already been found, it will prove difficult to use such a program in a device for real-time processing which requires an estimated running time.

In prior art systems, even if there were instructions required the same reference in a number of places in a continuous program, that reference had to be found anew for each instruction. This made the referencing efficiency extremely poor.

If the instruction code and operand are rewritten, the object program must be stored in the RAM. It will then take time to load the program in the RAM when the device is started, which will increase the start-up time that the system requires. A RAM with the same capacity as the ROM must be available to store the object program, which drives up the cost of the device.

### SUMMARY OF THE INVENTION

This invention was developed in consideration of the problems described above. Its first objective is to realize an information processing scheme such that the necessary references, including reference data specifying locations to be accessed in the memory, are found before the program is executed, and each result is stored in a link to the program. Then the locations to be accessed can be specified immediately by the reference data when the program is executed. The program's running time is stabilized and its speed is increased. It is well suited for use in a device which requires real time capability.

The second objective of this invention is to eliminate the need to load the program into a RAM. This would shorten the start-up time for the system, greatly reduce the required capacity of the RAM, and lower the production cost of the device.

The third objective of this invention is to enable the reference results to be read out of the ROM along with the program before the program is executed. This would further reduce the required capacity of the RAM and, when this system is used in a device, enable the program to run at high speed immediately after the system is started up.

With the invention disclosed in claim 1 of this application, when a program written in an interpreter language is run, the reference data specifying the locations to be accessed in the memory are extracted and the references are found before the program is executed. The results which are obtained are then linked to the program through the aforesaid reference data. When a program is executed which requires that certain data be referenced and accessed in the memory, the locations to be accessed in the aforesaid memory are specified based on the results linked to the program through these reference data.

The invention disclosed in claim 2 of this application comprises an information processing device which contains a program written in an interpreter language. To enable it to implement the scheme outlined above, it has a means to execute the aforesaid program and a means to link results of referencing to the program through the reference data specifying which locations are to be accessed in the memory. When it is to execute a program requiring that specified data be referenced and accessed in the memory, the means to execute the program uses the results of referencing, now linked to the aforesaid program through the reference data, to specify the locations to be accessed in the aforesaid memory.

If the aforesaid program in an interpreter language is a byte code program compiled from a source program written in Java, it consists of an object program (i.e., an instruction) requiring that names of variables and methods be referenced and data representing the actual contents (the names of the class, the variable, the method, etc.) of the reference data linked to the instruction. The means to execute the program is realized by the function of the interpreter. Through the aforesaid linked data, it verifies the content of the reference data as it executes programs in a given order.

Using the aforesaid reference data to find a reference means referencing certain data by means of the reference data and specifying the locations to be accessed in the memory so that no further reference processing will be necessary.

For example, finding a field reference would mean using the character data indicated by the program, such as the name of the class and variable, to obtain the address where the specified variable is stored and the data which correspond to that address (the aforesaid index to the field table). Finding a method reference would mean using character data such as the name of the method to obtain the address where the specified method is stored and the data which correspond to that address (the aforesaid index to the method table). Finding a class reference would mean using character data representing the name of the class to obtain the address where the data related to the methods and variables in the indicated class (the aforesaid class data) are stored and the data which correspond to that address (the aforesaid index to the class table).

With the invention disclosed in claim 3 of this application, if the aforesaid program consists of an object program in byte code and data which represent the content of reference data linked to that program, the results of the aforesaid referencing will be stored in the link information of the aforesaid object program. With the invention disclosed in claim 4 of this application, the link information contains code data of a number of fixed lengths. The aforesaid results of referencing are stored in a location determined by the head code data.

With the invention disclosed in claim 5 of this invention, the object program in byte code and its link information are read out of the ROM to execute the program.

With the invention disclosed in claim 1 of this application, the results obtained by referencing the data which specify locations to be accessed in the memory are stored as links to the program before it is executed. This allows the memory to be accessed speedily and the designated processing to be executed immediately after the system is activated. It also stabilizes the program's running time, making it possible to accurately predict that time.

The results of referencing the data are linked to the program through the reference data. This makes it unnecessary to rewrite the program as the data are referenced or load the program into the RAM when the system is activated.

The fact that the results of referencing are linked to the program without rewriting it means that a program which requires the same reference data to be looked up more than once will not have to repeatedly reference them as was the case in prior art programs.

With the invention disclosed in claim 2 of this application, for every set of reference data the previously obtained results of referencing will be linked to the program at the moment the system is activated. This enables processing to be executed speedily as soon as the program is started up.

With the invention disclosed in claim 3 of this application, the results of referencing the data are stored in the link information indicating the content of the reference data specified by the object program. In this way the results of referencing are linked to the program using the existing configuration of the program's links.

With the invention disclosed in claim 4 of this application, the results of referencing the data are stored in a location specified by the head code data in the link information. This enables the results to be retrieved easily. The location where the referencing results for each data file are stored is checked before the program is run. This enables the referencing results to be distinguished easily.

With the invention disclosed in claim 5 of this application, the link information containing the referencing results is stored with the object program in a ROM. This allows the program to run at high speed immediately after the system is started up.

### BRIEF DESCRIPTION OF THE DRAWINGS

FIG. 1 shows the configuration of an information processing system related to the first preferred embodiment of this invention.

FIG. 2 illustrates how the class file data are configured in this embodiment.

FIG. 3 shows the order of processing in an information processing system configured as in FIG. 1 from the moment the system is started up until the program has been executed.

FIG. 4 shows details of the processing in Step 4 of the aforesaid FIG. 3.

FIG. 5 shows the configuration of an information processing system related to the second preferred embodiment of this invention.

FIG. 6 illustrates how the class file data are configured according to a prior art.

FIG. 7 shows the configuration of the table of classes and the table of fields used to find field references.

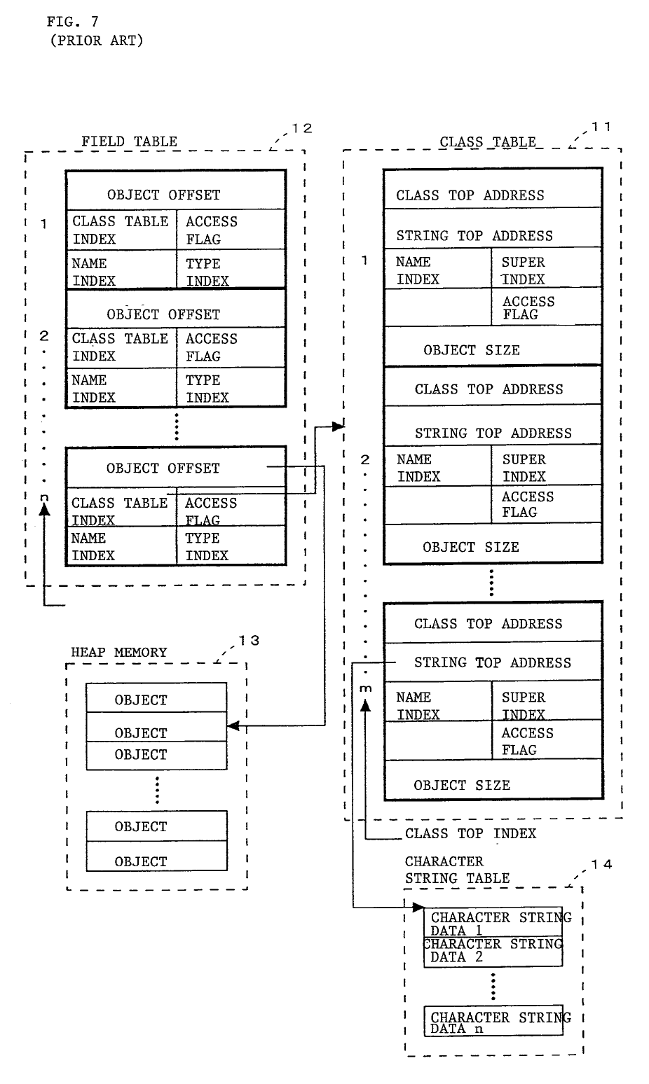

FIG. 8 shows the chain of processing in a system according to the prior art.

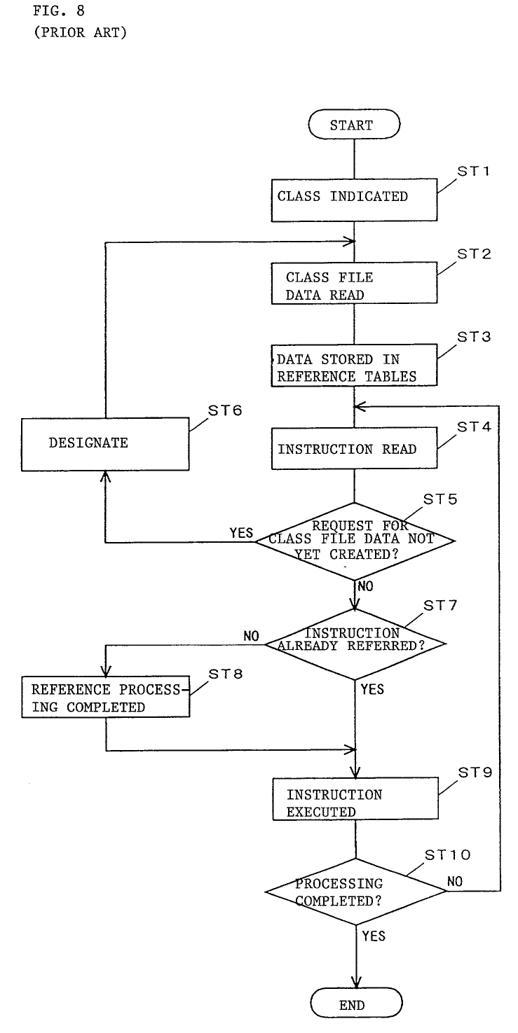

### DETAILED DESCRIPTION OF THE INVENTION

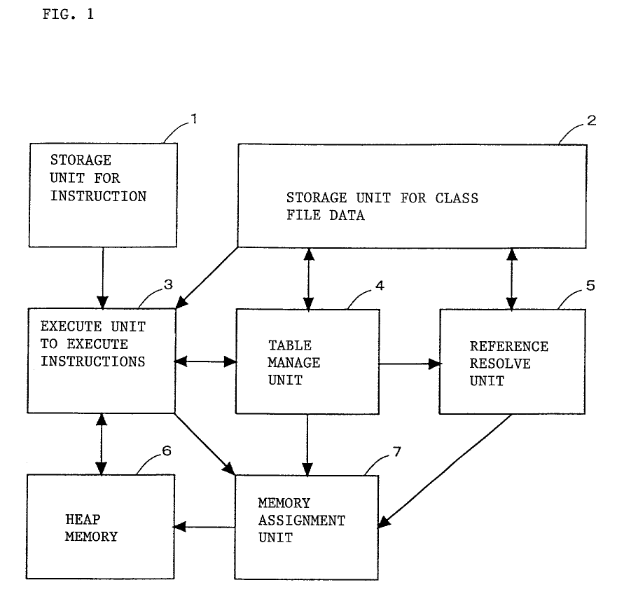

FIG. 1 shows the configuration of an information processing system related to the first preferred embodiment of this invention.

This information processing system comprises a device which contains a computer. The system executes a byte code program (hereafter simply referred to as “a program”) compiled from a Java source program. It consists of storage unit 1 for instructions; storage unit 2 for class file data; unit 3 to execute instructions; unit 4 to manage tables; unit 5 to resolve references; heap memory 6; and unit 7 to assign memory. Of these components, the four processing units, execution unit 3, management unit 4, resolution unit 5 and assignment unit 7, are realized by a Java interpreter. Instruction storage unit 1 is set up in the computer's ROM; data storage unit 2, heap memory 6 and the various reference tables created by management unit 4 are set up in a RAM.

Among the byte code programs, only the aforesaid instructions, i.e., the object program consisting of instruction codes and operands, are stored in the aforesaid instruction storage unit 1.

Class file data consisting of the reference data assembled for each class which indicate the actual content of the references specified by instructions are set up in storage unit 2. The reference data in a given class are represented by numerous data sets linked to the program using the aforesaid entry numbers. The head entry number of the reference data specified by an instruction which requests a reference is written into the operand of that instruction.

Table management unit 4 creates reference tables, such as a class table, a field table and a method table, from the class file data for each class just as was done in prior art schemes. The data organized in these reference tables are supplied as needed to execution unit 3, resolution unit 5 and assignment unit 7.

Execution unit 3 reads the instructions out of storage unit 1 one by one and executes them.

Memory assignment unit 7 sets up a work area in heap memory 6 for each instance generated by the execution of the program in response to a command from execution unit 3. Based on the value of the aforesaid object offset, it assigns a given address in the said work area to the variables for each instance.

Resolution unit 5 resolves references requested by an instruction. In this embodiment, references indicated by name data contained in the class file are resolved by finding the names before the program is executed, and the results obtained are written into the class file data.

The technique used to resolve the references is identical to that employed in the prior art. For example, the result of resolving a field reference would be a field table index, and the result of resolving a method reference would be a method table index. These indices would be written into the class file data. For a class reference, a class table index would be obtained for the class name that was indicated and stored as a result in the class file data.

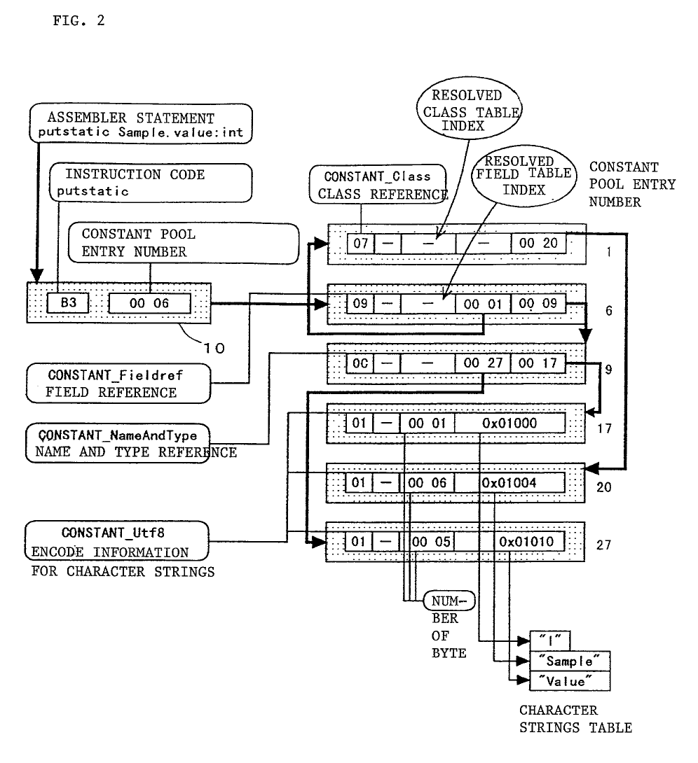

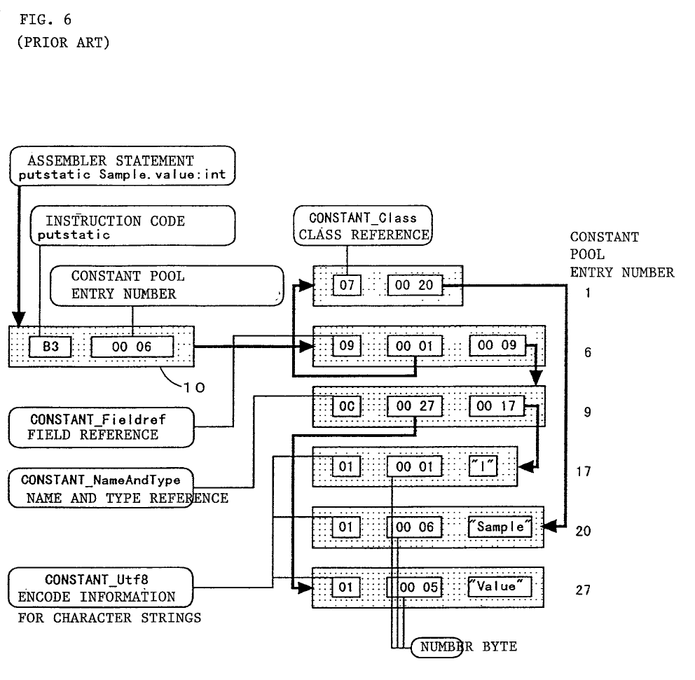

FIG. 2 illustrates how the class file data are configured in this embodiment. Just as in the prior art configuration shown in FIG. 6, the figure extracts the reference data for a single instruction.

In this embodiment, as in the prior art, various code data are linked to the code data for entry number 6, the “field reference” which is at the head of the list. These character data indicate the name of the class, variable and type of variable, as well as what sort of reference they represent.

These code data have a fixed length. As in the prior art, a flag is stored at the head of each set of code data. Other data are stored at the end of the code (in the example, on the right side). A blank space (indicated in the drawing by a dash) is left in the center.

Because this embodiment requires that all code data must have a fixed length, the character string representing the name is stored in a separate table of character strings. The aforesaid table is organized in class units. The table number for the character string table (in the drawing, 0) and the locations of those character strings in the table (in the drawing, represented by the numerals 1000, 1004 and 1010) are stored as location data in entry numbers 17, 20 and 27.

The aforesaid results of resolving the references are stored in the blank space provided in the head entry of the aforesaid reference data. In the example shown, the field table index obtained by resolving the field reference (hereafter referred to as the “resolved field table index”) is stored in the blank space in entry number 6, which is at the head of the link for the aforesaid reference data. The class table index obtained by the process of resolving the aforesaid field reference (hereafter referred to as the “resolved class table index”) is stored in the blank space in entry number 1, which is linked from entry number 6 to the storage location of the class name. The blank spaces in entry numbers other than 1 and 6 remain empty.

The location in which the index is stored in the aforesaid blank space is fixed, so it is easy to determine whether a field reference can be resolved by looking at the variable name.

For reference data which represent a method name in the class file data, the method table index obtained by resolving the method reference (hereafter, the “resolved method table index”) is written into the head entry of the aforesaid reference data in the same way.

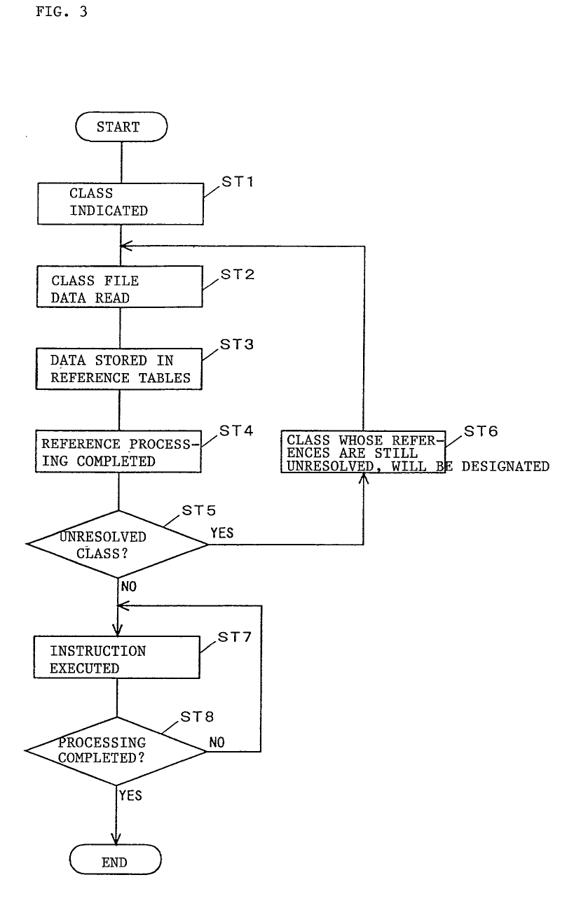

FIG. 3 shows the order of processing in an information processing system configured as in FIG. 1 from the moment the system is started up until the program has been executed.

In Steps 1 through 3 in the figure, when class file data have been created for a designated class, various reference tables, including class, field and method tables, are set up just as in the prior art.

In Steps 4 through 6, the aforesaid resolution unit 5 resolves the references using the variable and method names in the class file data. Until references have been resolved for all the class file data, classes whose references are still unresolved will be designated in order in Step 6, and their references will be resolved. When references have been resolved with respect to the class file data for every class, the answer in Step 5 will go to “no”, and instructions will be executed in order in the loop in Steps 7 and 8.

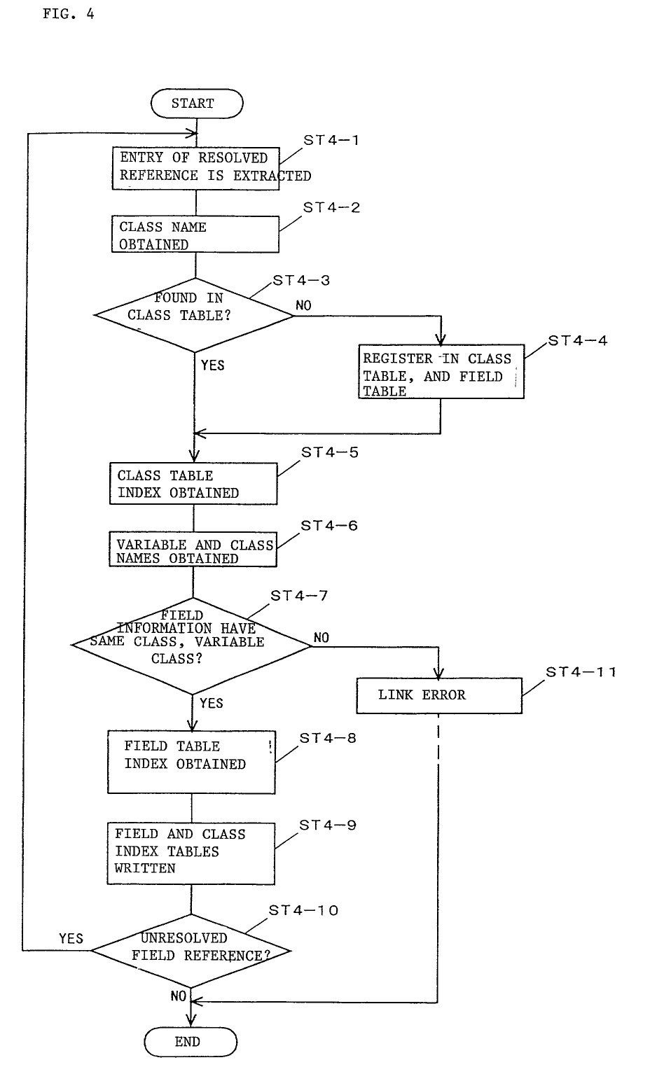

FIG. 4 shows details of the processing in Step 4 of the aforesaid FIG. 3. To simplify the explanation, the order shown is that used to obtain a field table index by resolving a field reference.

We shall next explain, with reference to the flow chart in FIG. 4, the order of processing used to resolve the field reference in the class file data shown in the aforesaid FIG. 2.

In Step 4-1, resolution unit 5 extracts from the class file data an entry (entry number 6) whose references have not yet been resolved. This will be an entry with the field reference tag “09” and which does not have a resolved field index. In Step 4-2, unit 5 traces in order, from the aforesaid data it extracted in Step 4-1, the data for the class name reference (entry number 1) and its link information (entry number 20), to obtain the name of the class to which the aforesaid variable belongs.

Resolution unit 5 checks whether a class with this name can be found in the class table. If it is there, unit 5 obtains a class table index for that class (Steps 4-3 and 4-5). If there is no class in the table with that name, in Step 4-4 unit 5 uses the aforesaid class file data for that class to enter it in the class table and the field table, and it obtains a class table index.

From the data in entry number 6 it extracted in the aforesaid Step 4-1, resolution unit 5 then follows, in order, the reference data for the name and type (entry number 9) and their link information (entry numbers 27 and 17). In this way it obtains the variable and class names (Step 4-6). It retrieves the field table and gives it the class table index obtained in the aforesaid Step 4-5. It extracts the field data which match the variable and type names obtained in Step 4-6 and obtains the field table index attached to these data (Step 4-8).

When it obtains the field table and class table indices in the aforesaid Steps 4-5 and 4-8, resolution unit 5 writes them into the designated blank space in the aforesaid class file data (Step 4-9).

Unit 5 continues, in the same way, to extract in order the data whose references are not yet resolved, the data which have the field reference tag “09”. It obtains field and class table indices from the class, variable and type names it finds by following the data linked to these, and it writes the values for each index in the class file data.

When unit 5 retrieves a field table and finds that it has no field data which match the combination of class table index, variable name and type name, the answer in Step 4-7 goes to “no”, and we move to Step 4-11, which is processed as a link error.

Thus the field references for every program variable are resolved through the variables themselves before the program is executed. The resolved field table index is stored in the blank space within the entry number representing the instruction which indicates that field reference. Thus when execution unit 3 is going to execute the aforesaid instruction 10, it obtains the aforesaid resolved field table index from the entry number written into the operand of instruction 10. It accesses the field it finds in the object offset value it obtains from the values in the index and executes the instruction.

The reference data containing character data representing the name of the class (consisting of entry number 1 with the aforesaid tag “07” attached to it and entry number 20, the linked entry number which represents the character string for the class name) are linked to the instruction which required the class reference. The aforesaid resolved class table index is written into the blank space in the head entry number. Accordingly, execution unit 3 obtains the aforesaid resolved class table index through the entry number written into the operand. By reading out the class data which correspond to this index, it can easily obtain the data associated with the objects and methods in that class.

References are also resolved in the same way before executing the program for instructions requiring that a method be referenced. In this case a resolved method table index is written into the head entry number of the reference data linked to the instruction. When this instruction is to be executed, the method table index obtained from the entry number in the instruction's operand tells unit 3 where the program for the method is stored, and the method can be accessed immediately.

If a program contains an instruction which generates a string object representing a character string in the class, the references are resolved for that object's name the first time the instruction is executed. The results are written into the class file data so that instructions which require that the string object be referenced can be executed at high speed.

Two tables are set up for a string object: a character string table in which is stored a character string representing that object and an object table which indicates the class to which the object belongs and the location in the aforesaid character string table where its character string is stored. When an instance is generated, data are entered which are linked mutually and reciprocally to the aforesaid character string and object tables. When a reference is resolved, just as was described above, an object table index obtained by resolving the references is written into the head entry number of the reference data linked to the instruction. Thereafter, whenever a program requires that a string object be referenced, the object table index for the object indicated by the class file data is read out. The location in the character string table where the string is stored can be found quickly so that the pertinent character string data can be accessed.

With the information processing system described above, when name data are referenced, all the reference data are extracted from the class file and the reference processing is resolved before the instruction indicating that a given address should be accessed is carried out. Since the results are stored in the location where read-out of the reference data linked to the instruction's operand begins, the addresses of the destinations to be accessed for each instruction can be completely specified using the results in the class file data as soon as the program is started up, and the instructions can be carried out at high speed. There will be no difference between the program's running times the first time it is executed and the subsequent times it is executed. This allows the program's running time to be predicted accurately.

Since the results of referencing are written into the aforesaid head entry of the operand without rewriting the instruction, the results are linked to the program using the existing link configuration. To execute an instruction using these referencing results, execution unit 3 has only to read the results of referencing out of the head entry written in the operand. There is no need to significantly change the design of the interpreter.

Because the referencing results are written in a specific location in the head entry, they can be read out easily. When resolving the references, the processing involved in finding data whose references are still unresolved is also simplified.

In the information processing system of this embodiment, there is no need to rewrite instructions. Reading an instruction out of the ROM and executing it doesn't require that the program be loaded at start-up time. Once power is supplied to the device, the system can start up swiftly. Because it is not necessary to load the program, the capacity of the RAM can be substantially reduced.

Because the aforesaid results of referencing are stored so as to correspond to the reference data in the class file, instructions which require that the same data be referenced can share the results. There is thus no need to resolve the same reference repeatedly, and the references can be resolved more efficiently.

To apply the method of storing the referencing results for each set of reference data in the aforesaid class file data, the class file data in which are written the referencing results already obtained can be stored in the ROM, or a reference table can be created according to the class file data and both the data and the table can be stored in the ROM. With this method, it will not be necessary to resolve the references after starting up the system. As soon as the program is activated, high-speed processing can commence. This information processing system is particularly suited for use in compact devices which require real-time processing.

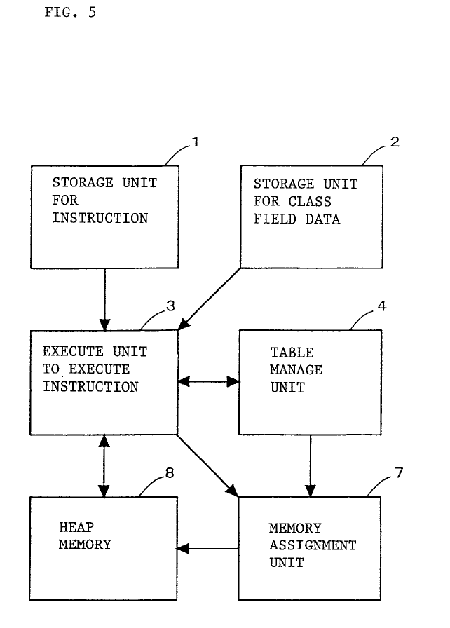

FIG. 5 shows the configuration of an information processing system related to the second preferred embodiment of this invention.

The information processing system of this embodiment has the same configuration as that shown in FIG. 1 above, with the exception of resolution unit 5. However, all the reference tables created by storage unit 2 and table management unit 4 are set up in the ROM along with instruction storage unit 1. The rest of the configuration is identical to that of the aforesaid first embodiment.

Class file data for all classes stored in instruction storage unit 1 are stored in storage unit 2 for class file data. Table management unit 4 manages the class, field, method and character string tables in which class data are recorded.

Index data representing the results already obtained by resolving the references for the variable, method and class name for each class are stored in storage unit 2 for class file data, just as in the aforesaid first embodiment.

With an information processing system configured as described above, the system is activated as soon as power is connected. Class file data in which the referencing results are written and reference tables are set up, and all instructions are carried out at high speed based on the results of referencing those instructions. This information processing system does not require a large-capacity RAM, so the device which contains it can perform high-speed information processing at a low cost.

With the inventions disclosed in claims 1 and 2 of this application, the reference processing is resolved before the program is executed using the reference data which specify the locations in the memory to be accessed. The results of referencing are then linked to the program through the reference data. Thus when the program is started up, the stored referencing results can be used to access the memory quickly. This scheme stabilizes the program's running time and allows it to run at high speed. Because the program's running time is invariant, the information processing system is suitable for a device using real-time processing, which requires an accurate prediction of the program's running time.

There is no need to rewrite the program when the references are resolved. This obviates the need to load the program into a RAM. Since less time is required from the moment the power is connected to the moment the system is activated, the capacity of the RAM can be significantly reduced. References need to be resolved only once for programs which indicate that the same data be referenced more than once. References can be resolved in a shorter time, and the program will be executed sooner.

With the invention in claim 3, the existing configuration of the program's links is used to link the referencing results to the program. There is thus no need to greatly modify the design of the interpreter.

With the invention disclosed in claim 4, the referencing results can be obtained efficiently when the program is to be run from a designated location in the head code data of the link information. This allows the program to run even faster. When the references have been resolved before the program is executed, the program checks whether the results have been written into the aforesaid designated location. This allows data with unresolved references to be recognized easily so that resolution processing can be speeded up.

With the invention disclosed in claim 5 of this application, the program to be executed and the referencing results linked to it are read out of the ROM before the program is run. Then as soon as power is connected, the program can be activated and high-speed processing can be performed. There is no need to load the program or the results into the RAM, so the RAM's capacity can be further reduced. This scheme allows a device to have a program in it which can execute high-speed processing at a low cost.

What is claimed is:

1. A program executing method to execute a program written in an interpreter language, comprising the steps of:
extracting reference data used for specifying a location to be accessed in a memory, and resolving a reference using said reference data;
storing result data of said resolved reference linking to said program through said reference data, said two steps being executed before said program is executed; and
specifying a location in said memory to be accessed based on said result data of said resolved reference linking to said program through said reference data, when said program is executed which requires to access said memory referring predetermined data.

2. An information processing device provided with a program written in an interpreter language, comprising:
a storing means to store result data of a resolved reference linking to said program through a reference data to specify a location in a memory to be accessed;
a program executing means to execute said program, which specifies said location in said memory to be accessed based on said result data of said resolved reference linking to said program through said reference data, when said program is executed which requires access to said memory referring predetermined data.

3. An information processing device according to claim 2, wherein said program comprises an object program in byte code and data which represent the content of reference data linked to said program, and said program executing means stores said result data of said resolved reference in a link information provided for linking to said object program.

4. An information processing device according to claim 3, wherein said link information provided for linking to said object program contains code data of a number of fixed lengths, and said result data of said resolved reference is stored in a predetermined location in a head code data.

5. An information processing device according to claim 4, wherein said object program and said link information are read out of a ROM at the time of executing said program.
